(19) United States
(12) Patent Application Publication
(10) Pub. No.: US 2007/0250471 A1
(43) Pub. Date: Oct. 25, 2007

(54) Running XPath queries over XML streams with incremental predicate evaluation

(75) Inventors: MARCUS FELIPE FONTOURA, LOS GATOS, CA (US); VANJA JOSIFOVSKI, LOS GATOS, CA (US); ZIV BAR-YOSSEF, HAIFA (IL)

Correspondence Address: IP AUTHORITY, LLC;RAMRAJ SOUNDARARAJAN, 9435 LORTON MARKET STREET #801, LORTON, VA, 22079, US

(73) Assignee: INTERNATIONAL BUSINESS MACHINES CORPORATION, Armonk, NY (US)

(21) Appl. No.: 11/380,136

(22) Filed: Apr. 25, 2006

(51) Int. Cl. G06F 17/30

(52) U.S. Cl. 707/2

(57) ABSTRACT

A method that eagerly evaluates predicates of XPath queries over XML document nodes for a set of commonly known functions and operators (including arithmetic, general comparison, value comparison, Boolean operators, etc.) without materializing sequences is discussed. Such eager evaluation of predicates reduces the amount of buffer space required since evaluation sequences have to be buffered only partially during the predicate evaluation process. Document nodes to be selected by a query are determined earlier so that they can be outputted without buffering.

### BACKGROUND OF THE INVENTION

1. Field of Invention

The present invention relates generally to the field of XPath evaluation. More specifically, the present invention is related to evaluation of predicates in XPath queries.

2. Discussion of Prior Art

XPath evaluation over streams of XML data has been a focus of intense research effort in the last few years. All of the evaluation proposals and implementations that have been proposed follow the XPath language semantics when evaluating predicates which require argument sequences to be fully materialized before evaluation of the predicate.

Moreover, prior art techniques for evaluating XPath and XQuery queries over XML streams suffer from excessive memory usage on certain queries and documents. The bulk of memory used is dedicated to the two tasks of: storage of large transition tables; and buffering of document fragments. The former emanates from the standard methodology of evaluating queries by simulating finite-state automata. The latter is a result of the limitations of the data stream model.

Finite-state automata or transducers are natural mechanisms for evaluating XQuery/XPath queries. However, algorithms that explicitly compute the states of these automata and the corresponding transition tables incur memory costs that are exponential in the size of the query in the worst-case. The high costs are a result of the blowup in the transformation of non-deterministic automata into deterministic ones. Article titled, “On the memory requirements of XPath evaluation over XML streams” by Bar-Yossef et al., investigates the space complexity of XPath evaluation on streams as a function of the query size, and shows that the exponential dependence is avoidable. Moreover, the article illustrates an optimal algorithm whose memory depends only linearly on the query size (for some types of queries, the dependence is even logarithmic).

Another major source of memory consumption is buffers of document fragments. During XPath evaluation there is a need to store fragments of the document stream. The buffering seems necessary, because in many cases at the time the algorithm encounters certain XML elements in the stream, it does not have enough information to conclude whether these elements should be part of the output or not (the decision depends on unresolved predicates, whose final value is to be determined by subsequent elements in the stream). For certain queries, documents buffering is unavoidable. Thus, there is a need to optimize the buffering requirements during XPath evaluation and the prior art fails to provide a method or a system to meet this need.

The following references generally describe the processing of mark-up language data.

U.S. patent application publication to Breining et al., (2003/0212664 A1), discloses a relational engine to process XML documents by querying data in the document, however does not process XML streams directly.

U.S. patent application publication (2004/0034830 A1), discloses a method for transforming an XML document in a streaming mode and matching of the structural parts of the XML document (parent/child relationships).

U.S. patent application publication assigned to International Business Machines Corporation, (2004/0205082 A1), discloses a method for querying a stream of mark-up language data wherein predicate evaluation is performed by fully materializing argument sequences.

U.S. patent application publication (2005/0091588 A1), discloses a method of evaluating expressions in a stylesheet at the compile, parse or transformation phases.

U.S. patent application publication to Fontoura et al., (2005/0114316 A1), discloses the use of indexes to speed up XML processing over streams.

U.S. patent application publication (2005/0114328 A1), discloses an XQuery evaluation engine usable over streams.

Article titled, “The complexity of XPath query evaluation” by Gottlob et al., discusses how both the data complexity and the query complexity of XPath 1.0 fall into lower (highly parallelizable) complexity classes, but that the combined complexity is PTIME-hard.

None of these references address the need to optimize buffering requirements during evaluation of Xpath queries.

Whatever the precise merits, features, and advantages of the above cited references, none of them achieves or fulfills the purposes of the present invention.

### SUMMARY OF THE INVENTION

A computer-based method of evaluating a query over a mark-up language document by performing incremental evaluation of predicates, said method comprising the steps of: a) receiving mark-up language document nodes as a stream of events; b) reading events one-by-one from said received stream of events and matching said read events with nodes in a parse tree associated with said query; c) if said read events match a node in said parse tree that is a term in a predicate, then, performing incremental evaluation of said predicate, discarding buffers used to store mark-up language document nodes participating in said predicate evaluation and performing steps b and c until an end document event is received; else performing steps b and c until an end document event is received.

A computer-based method of evaluating a query over a mark-up language document by performing incremental evaluation of predicates, said method comprising the steps of: a) receiving mark-up language document nodes as a stream of events; b) reading events one-by-one from said received stream of events and matching said read events with nodes in a parse tree associated with said query; c) buffering mark-up language document nodes for said matched read events; d) if said read events match a node in said parse tree that is a term in a predicate, then, i) performing incremental evaluation of said predicate and discarding buffers used to store mark-up language document nodes participating in said predicate evaluation; ii) if said predicate has been satisfied in step i), then outputting results and discarding buffers used to store intermediate mark-up language document nodes that can be part of results, else performing steps b-d until an end document event is received; else, performing steps b-d until an end document event is received.

A computer-based system to evaluate a query over a mark-up language document by performing incremental evaluation of predicates, said system comprising: a query parser receiving said query and generating a parse tree; a markup-language document processor receiving markup-language document nodes and generating a stream of events; buffers comprising said predicate buffers and said result buffers, said predicate buffers used to store mark-up language document nodes participating in said predicate evaluation and said result buffers used to store intermediate mark-up language document nodes that can be part of results; and an evaluator: receiving said generated parse tree and said generated stream of events; evaluating said received parse tree by reading events one by one from said received stream of events and matching said read events with nodes in said parse tree; buffering mark-up language document nodes for said matched read events; and performing incremental evaluation of predicates and discarding predicate buffers if said read events match a node in said parse tree that is a term in a predicate; and outputting results and discarding result buffers if said predicate has been satisfied.

### BRIEF DESCRIPTION OF THE DRAWINGS

FIG. 1 illustrates steps performed by an XPath evaluation algorithm, as per an embodiment of the present invention.

FIG. 2 illustrates states of the principal data structures used by the algorithm, as per the present invention.

FIG. 3 illustrates steps performed by an XPath evaluation algorithm, as per another embodiment of the present invention.

FIG. 4 illustrates startElement event handler code, as per the present invention.

FIG. 5 illustrates endElement event handler code, as per the present invention.

FIG. 6 illustrates a system to perform incremental evaluation of predicates, as per the present invention.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention. It should be understood that while the present invention algorithm described herein discusses the XPath query evaluation on XML (extensible mark-up language) documents, any other mark-up language document could be evaluated using this algorithm. Hence, the type pf mark-up language document used should not be used to limit the scope of the invention.

The present invention provides an algorithm that eagerly evaluates predicates of XPath queries over XML document nodes for a set of commonly known functions and operators (including arithmetic, general comparison, value comparison, Boolean operators etc.) without materializing sequences. Such eager evaluation of predicates reduces the amount of buffer space required since evaluation sequences (i.e. data values corresponding to document nodes matched to leaf nodes in the predicate) have to be buffered only partially during the predicate evaluation process. Further, if it is determined that a document node is selected by the query and the predicate has already been satisfied (i.e. evaluated to true) with respect to the context, the node can be output without buffering.

The existential XPath semantics as described in “XML Path Language (XPath), Version 1.0) by Clark et al., assumes that in the evaluation of a predicate (corresponding to some query node) over a document node, every leaf in the expression tree of the predicate is evaluated into a sequence of data values. Internal nodes are later evaluated over the resulting sequences.

As an example, consider the evaluation of query Q=/a [b>5]/c over the following document D:

<a> <c>c1</c> <b>4</b> <c>c2</c> <b>6</b> <b>3</b> <c>c3</c> </a>

If existential XPath semantics is followed, in the evaluation of the predicate [b>5] (‘b’ and 5 are terms in the predicate, and ‘>’ the operator), first the sequence (4, 6, 3), corresponding to the data values of the matches to the ‘b’ node is created. Only then the sequence is compared to the constant 5, and evaluates to true because at least one its entries is greater than 5.

However, in the above example the fact that the predicate is going to evaluate to true is known already when the second ‘b’ node in the document (whose data value is 6) is encountered. This knowledge can be exploited and predicates can be eagerly evaluated as per the present invention, i.e. the predicates can be evaluated incrementally when a document node matches a query node that is a term in the predicate.

In the above example, when using the algorithm of the present invention, all the data values of the ‘b’ nodes will not have to be buffered simultaneously. Moreover, the first two ‘c’ nodes will be outputted as soon as a ‘b’ node whose data value equal to 6 is encountered and the third ‘c’ node will be outputted immediately when encountered.

Thus, in simple terms document nodes in the present invention are buffered only if: 1) it is not yet clear whether they will be selected by the query or not; or 2) their value may be required to evaluate pending predicates.

The existential semantics of XPath implies that a predicate of the form /c[R(a,b)] (this form represents a multi-variate comparison predicate), where R is any comparison operator (e.g., =, >), is satisfied if and only if the document has a ‘c’ node with at least one ‘a’ child with a value x and one ‘b’ child with a value y, so that R(x,y)=true. Thus, if all the ‘a’ children of the ‘c’ node precede its ‘b’ children, an evaluation algorithm will need to buffer all the distinct values of the ‘a’ children, until reaching the first ‘b’ child.

Such buffering is necessary when R is an equality operator (i.e., =, !=), however, is not needed for inequality operators (i.e., <, <=, >, >=), because for them it suffices to buffer just the maximum or minimum value of the ‘a’ children. The present invention evaluation algorithm utilizes these algebraic properties of predicate operators to further reduce buffering requirements. For uni-variate predicates, the values can be discarded after each predicate evaluation.

As per the present invention, the algorithm receives an XML document as stream of SAX (Simple API for XML) events, which is known in the art, and takes actions when it receives the startElement and endElement events for each node. However, the algorithm could also receive the XML document as a data tree representation directly without performing any processing on the document.

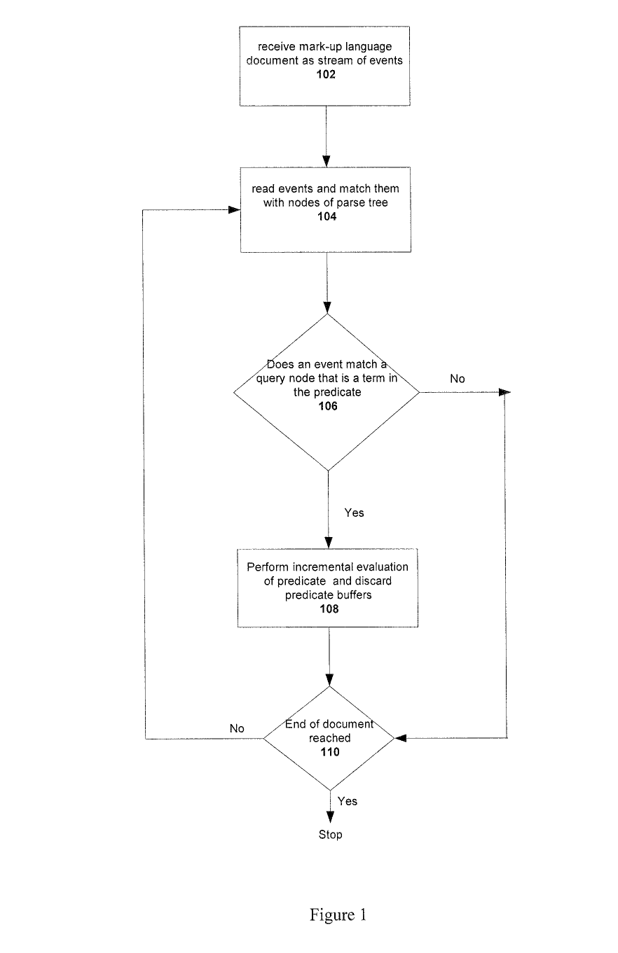

FIG. 1 illustrates the basic steps performed by an XPath evaluation algorithm, as per the preferred embodiment. The algorithm receives as input an XML document as a stream of events and a parse tree generated for an XPath query. As defined in the XPath Standard (“XML Path Language (XPath) 2.0” by Berglund et al., and (“XML Path Language (XPath) Version 1.0” by Clark et al., the algorithm returns references to a Query Data Model (QDM) representation of the matching nodes.

As shown in FIG. 1, in step 102, mark-up language document nodes are received as a stream of events. A parse tree associated with an XPath query is evaluated by reading events one by one from the SAX event stream and matching these events with the nodes of the parse tree (step 104). If an event matches a query node that is a term in the predicate in step 106, incremental evaluation of the predicate is triggered in step 108 and predicate buffers (i.e. buffers used to store mark-up language document nodes participating in predicate evaluation) are discarded upon evaluation. The algorithm continues performing steps 106-108, (i.e., receiving further events from the SAX stream, evaluating the parse tree and incrementally evaluating the predicate), until an end document event is received.

Principal data structures used by the algorithm as per the present invention are the following:
a) validation array: a boolean array used for checking if the predicate of a given query node has already been satisfied.
b) result buffers: an array of buffers, in which document nodes that may have to be outputted as part of the result are stored; and
c) predicate buffers: an array of buffers, in which document nodes that participate in the evaluation of pending predicates are stored.

The evaluation process performed by the algorithm utilizing the above mentioned principal data structures is discussed based on the earlier example of evaluation of query Q=/a [b>5]/c over the following document D:

<a> <c>c1</c> <b>4</b> <c>c2</c> <b>6</b> <b>3</b> <c>c3</c> </a>

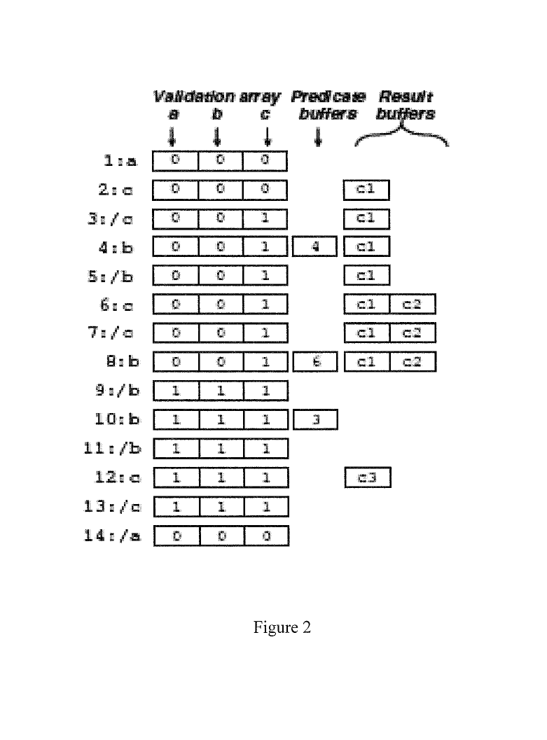

FIG. 2 describes the states of the principal data structures used by the algorithm of the present invention, after each event which is encountered during the evaluation of evaluation of query Q over document D. The query is evaluated by reading events one by one from the SAX event stream. At the beginning the validation array for each node is false (0) and all buffers are empty. This indicates that none of the predicates have been satisfied yet and that no nodes are being considered as part of the results or for predicate evaluation.

When the first ‘c’ (event 2) is encountered, it is added to the result buffers since at this point the predicate b>5 is still unverified and thus it is not known whether this ‘c’ will be selected by the query or not. When ‘c’ is closed (event 3) the validation array entry for ‘c’ can be set to true (11) since ‘c’ has no predicates to satisfy in the query. When the first ‘b’ arrives (event 4) its content is buffered in the predicate buffers in order to be able to evaluate the predicate [b>5]. When ‘b’ closes (event 5) the predicate can be fully evaluated, which is false and therefore the validation array entry for ‘b’ remains unchanged. After the predicate is evaluated, the predicate buffers are discarded. In events 6 and 7 the second ‘c’ is added to the result buffers since the predicate on ‘b’ is still unverified. In event 8 the next ‘b’ occurrence is added to the predicate buffers and in event 9 the predicate on ‘b’ is finally evaluated to true. At this point, we turn the validation array entry for ‘b’ to true. In addition, since the validation entry for ‘c’ is already true, all the constraints on ‘a’ are verified and the node a's validation array entry is set to true as well. This also allows the ‘c’ nodes that are in the output buffers to be emitted, since they are surely part of the result set. After these nodes are emitted all the result buffers are discarded. In events 10 and 11a new ‘b’ node that does not match the predicate is encountered. However, even though the predicate evaluation triggered in event 11 returns false, the validation array entry for ‘b’ is not reset. The reason for that is the existential semantics of XPath, that requires the predicate to be valid for just one of the ‘b’ nodes under a. When the next ‘c’ arrives in event 12 it is buffered just until ‘c’ closes (event 13). At that point it is emitted as a result and the buffer is discarded. Finally, when the ‘a’ node closes (event 14) the validation array bits are reset. If events 8 and 9 had not taken place, the predicate anchored at ‘b’ would remain false, and all the ‘c’ nodes stored in the result buffers would be discarded without being emitted when node ‘a’ closes in event 14.

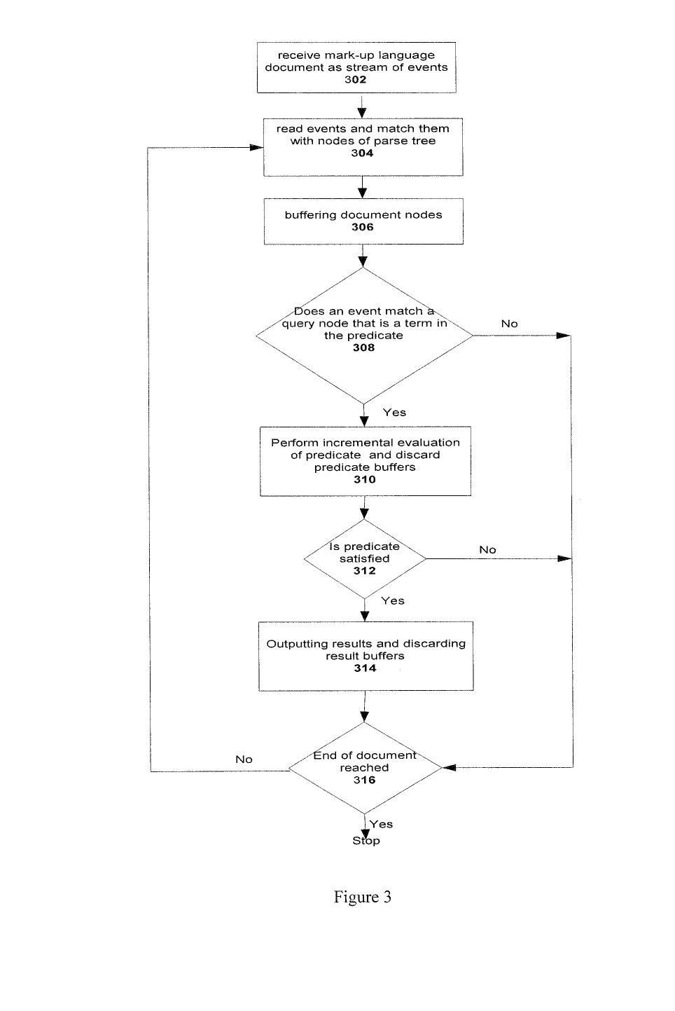

FIG. 3 illustrates the steps performed by an XPath evaluation algorithm as per another preferred embodiment of the present invention. In step 302, a mark-up language document is received as a stream of events. The parse tree associated with an XPath query is evaluated by reading events one by one from the SAX event stream and matching these events with nodes of the parse tree (step 304). Document nodes for the matched events are buffered in step 306. If an event matches a query node that is a term in the predicate in step 308, incremental evaluation of the predicate is triggered in step 310 and predicate buffers (i.e., buffers used to store mark-up language document nodes participating in predicate evaluation) are discarded upon evaluation. In step 312, it is determined if the predicate has been satisfied. If yes, then the results are outputted and result buffers (i.e., buffers used to store intermediate mark-up language document nodes that can be part of results) are discarded (step 314). The algorithm continues performing steps 310-314, (i.e., receiving further events from the SAX stream, evaluating the parse tree, incrementally evaluating the predicate and determining if the predicate has been satisfied), until an end document event is received. It is important to note that incremental evaluation of predicates allows for saving a lot of buffer space (i.e., buffering requirements) because: i) all the evaluation sequences do not need to be stored and ii) it is determined earlier if a predicate has been satisfied and any stored results can be output earlier; and also any results selected after a predicate has already been satisfied earlier can be output without buffering.

The evaluation process performed by the algorithm will now be described in detail. Suppose Q is the input query and D is the input document, given as a stream of SAX events. The algorithm tries to gradually construct matchings of document nodes with the query output node out(Q). Each completed matching results in one document node being outputted.

The present invention's algorithm is event-driven. As SAX events arrive, corresponding event handlers are called, updating the global variables of the algorithm. Only handlers of the startElement and endElement events are described in this application, however, other handlers may be implemented as well.

The present invention's algorithm gradually constructs the matchings on a “frontier” of the query. Initially, the frontier consists of the query root alone. When the algorithm receives a startElement event of a document node x, it searches for all the nodes u in the frontier, for which x is a “candidate match”, For each such node u, the children of U are added to the frontier as well. When the algorithm receives the endElement event of x, it removes the children of u from the frontier, and uses them to determine whether x is turned into a “real match” for u or not. The algorithm outputs x if and only if x is found to be a real match for out(Q). A document node x is a “candidate match” for query node u, if the name of x fits the node test of u and if x relates to the candidate match of parent(u) according to the axis of u. x is also a real match for u, if the predicate of u evaluates to true on x.

In order to determine if a document node x is a candidate match for a query node u, only the name of x and its “document level” (i.e., document depth) needs to be known. By comparing this level to the document level of the candidate match z for parent(u), it can be known whether x relates to z according to axis(u). Therefore, whether x is a candidate match for u already at the startElement event of u can be determined. On the other hand, determining whether x turns into a real match for u or not requires knowing the string value of x (if u is a leaf) or whether descendants of x are real matches for the children of v. This can be inferred only at the endElement event of x.

The algorithm maintains the following global variables. The first five arrays are always of the same size. Each entry in them corresponds to one query node in the frontier.
pointerArray: Pointers to the query nodes in the frontier.
IDArray: Unique IDs of the current candidate matches for the query nodes currently in the frontier.
levelArray: Document levels at which to expect candidate matches for the query nodes currently in the frontier. (Used for processing child axis.)
validationArray: Boolean flags indicating whether real matches for the query nodes currently in the frontier have already been found.
parentArray: Indices in the above arrays corresponding to the parent of each query node currently in the frontier.
predicateArray: Contents of document nodes that are needed for evaluating predicates of query nodes in the frontier.
resultArray: Contents of document nodes that are candidate matches for out(Q) and it is not yet clear whether they will turn into real matches.

In addition, the variable nextIndex contains the size of the first five arrays, nextPred contains the size of predicateArray and nextResult contains the size of resultArray.

At initialization, the query root is inserted to pointerArray, its levelArray entry is set to 0, its validationArray entry is set to false, and its parentArray entry is set to NULL. The variables nextIndex, nextPred, and nextResult are set to 0 and the arrays predicateArray and resultArray are left empty.

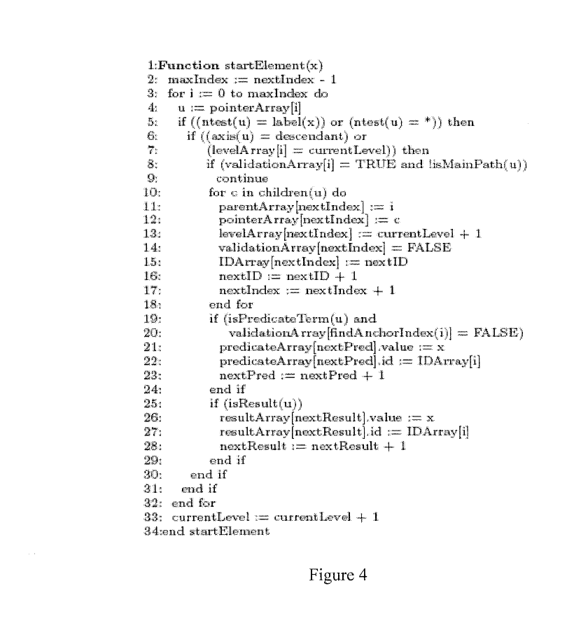

The startElement event handler, illustrated in FIG. 4, is called every time a new document node x starts. The function iterates over all the query nodes u in the frontier, for which x is a candidate match (lines 4-7 of FIG. 4). In lines 8-9, treatment of query nodes along the succession path of the query root (the “main path”) is distinguished from ones that are not. The reason is the following: For nodes along the main path, all possible matches in the document are found, because these may turn into distinct results in the output. On the other hand, nodes that do not belong to the main path are necessarily part of predicates. For predicate evaluation, all possible matches do not need to be found: it suffices to find at least one good match (due to the existential semantics of XPath). For example, if Q=/a[b>5]/c, then all the matches to the c node are looked at, but for the b node, as soon a match whose data value is greater than 5 is found, there is no need to look for any more matches.

If u is an internal node, checking whether x turns into a real match or not will require finding real matches for the children of u in the subtree rooted at x. Thus all the children of u are inserted into the frontier (lines 10-18).

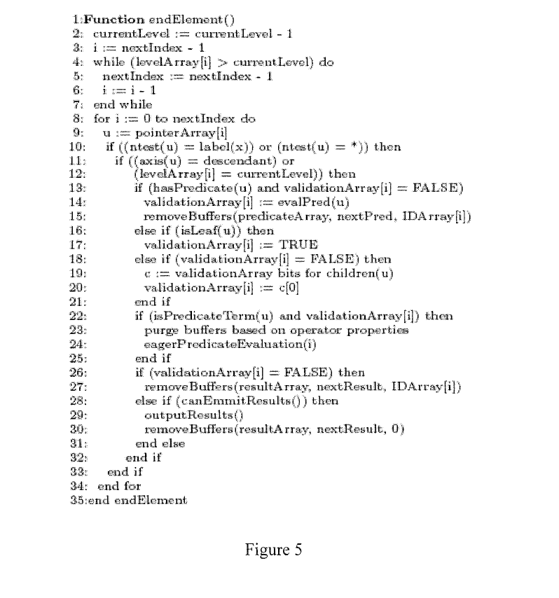

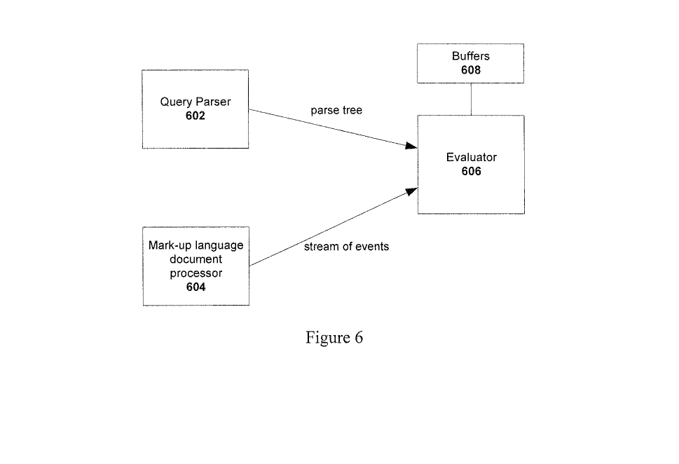

Function endElement, as illustrated in FIG. 5, is called once for every close element event in the document stream. It starts by decrementing the current level (line 1 of FIG. 5). It then checks if there are nodes in the global arrays that need to be removed since their parent is the node being closed (lines 2-7 of FIG. 5). EndElement then updates the validation array entries for the nodes being closed (lines 13-21). If the node being closed has a predicate (lines 13-15) the predicate is evaluated by invoking evalPred. Function evalPred simply evaluates the predicate tree anchored at the matched query node and returns true if the predicate is valid and false otherwise. In order to do the predicate evaluation evalPred may need to access the predicate buffers. After the predicate evaluation is done the predicate buffers are discarded (line 15). If the node being closed is a leaf, the validation array is set to true since it does not have any constraints that still need to be verified (lines 16-17). Finally, if the node being closed is an internal node that has no predicate (lines 18-20), it must have only one child node. Therefore its validation array entry is set to true only if the all the constraints in the child node have been satisfied, i.e., the validation array entry for the child node is true. In order to enforce the existential semantics of XPath just the validation array entry for the closing node is updated if it is not already set to true. If the node being closed is part of a predicate that predicate is eagerly evaluated (lines 22-24). For example, in query a[b>5]/c, when b is closed, the predicate anchored at a is eagerly evaluated. This eager evaluation allows for verifying predicates as soon as possible (i.e. at an earliest point during the evaluation), which in turn allows the results to be outputted and buffers to be discarded as soon as possible. Just before the eager evaluation the buffer array from entries that are not needed is purged, based on the operator properties. For example, for non-equality comparison only the maximum/minimum value is preserved. After all the predicates have been evaluated and all validation array entries have been set, a check is made to see if results can be outputted and result buffers discarded (lines 26-30). If the validation array entry for the closing node is false, all the result buffers seen after the closing node can be discarded (lines 25-26). Otherwise a check is made to see if all the query constraints have been satisfied, in which case all the results buffered so far are output and their buffers discarded (lines 27-30). Functions startElement and endElement use five auxiliary functions, for which only a textual explanation is provided as follows:
findAnchorIndex: finds the index of the next ancestor node that has a predicate anchored to it;
removeBuffers: removes all buffers that were added below the node that is closing;
eagerPredicateEvaluation: traverses the tree upwards and triggers predicate evaluation where needed; updates the validation array and clears the predicated buffers as it goes on;
canEmmitResults: checks if the validation array bits for nodes on the main path are set to true; in this case we can start outputting results
outputResults: outputs the results from the result buffers.
   FIG. 6 illustrates a system to evaluate a query over a mark-up language document by performing incremental evaluation of predicates. Query parser 602 receives XPath queries and generates a parse tree for each query. Mark-up language document processor 604 imports a data stream/document into a stream of SAX events. Evaluator 606 receives the parse tree and steam of events and evaluates the received parse tree by reading events one by one from the stream of events and matching the read events with nodes in the parse tree. Evaluator 606 performs the steps outlined in FIGS. 1 and 3 (i.e. evaluating the parse tree, buffering document nodes, performing incremental evaluation and discarding predicate buffers, determining if the predicate has been satisfied and outputting results and discarding result buffers). Buffers 608 comprise the predicate buffers and result buffers.

### CONCLUSION

A system and method has been shown in the above embodiments for the effective implementation of an algorithm for running XPath queries over XML streams with incremental predicate evaluation. While various preferred embodiments have been shown and described, it will be understood that there is no intent to limit the invention by such disclosure, but rather, it is intended to cover all modifications failing within the spirit and scope of the invention, as defined in the appended claims. For example, the present invention should not be limited by software/program, type of mark-up language document used, type of event handler used, type of queries used, computing environment, or specific computing hardware.

1. A computer-based method of evaluating a query over a mark-up language document by performing incremental evaluation of predicates, said method comprising the steps of:
a) receiving mark-up language document nodes as a stream of events;
b) reading events one-by-one from said received stream of events and matching said read events with nodes in a parse tree associated with said query;
c) if said read events match a node in said parse tree that is a term in a predicate,
then, performing incremental evaluation of said predicate, discarding buffers used to store mark-up language document nodes participating in said predicate evaluation and performing steps b and c until an end document event is received;
else
performing steps b and c until an end document event is received.

2. A computer-based method of evaluating a query over a mark-up language document by performing incremental evaluation of predicates, as per claim 1, wherein said stream of events are SAX events.

3. A computer-based method of evaluating a query over a mark-up language document by performing incremental evaluation of predicates, as per claim 1, wherein said markup language document is XML.

4. A computer-based method of evaluating a query over a mark-up language document by performing incremental evaluation of predicates, as per claim 1, wherein said query an XPath query.

5. A computer-based method of evaluating a query over a mark-up language document by performing incremental evaluation of predicates, as per claim 1, wherein said method performs additional steps of:
buffering mark-up language document nodes for said matched read events; and
if said predicate has been satisfied in step c, then outputting results and discarding buffers used to store intermediate mark-up language document nodes that can be part of results, else, continuing steps b and c until and end document event is received.

6. A computer-based method of evaluating a query over a mark-up language document by performing incremental evaluation of predicates, as per claim 1, wherein said incremental evaluation of predicate step utilizes algebraic properties of an operator in said predicate to reduce buffering requirements.

7. A computer-based method of evaluating a query over a mark-up language document by performing incremental evaluation of predicates, as per claim 5, wherein said incremental evaluation of predicate step verifies predicates at an earliest point during said evaluation of said parse tree; outputs results and discards buffers at said earliest point and eliminates buffering said matched read events after said earliest point, whereby buffering requirements are reduced.

8. A computer-based method of evaluating a query over a mark-up language document by performing incremental evaluation of predicates, as per claim 1, wherein said predicate is uni-variate or multi-variate.

9. A computer-based method of evaluating a query over a mark-up language document by performing incremental evaluation of predicates, said method comprising the steps of:
a) receiving mark-up language document nodes as a stream of events;
b) reading events one-by-one from said received stream of events and matching said read events with nodes in a parse tree associated with said query;
c) buffering mark-up language document nodes for said matched read events;
d) if said read events match a node in said parse tree that is a term in a predicate, then,
i) performing incremental evaluation of said predicate and discarding buffers used to store mark-up language document nodes participating in said predicate evaluation;
ii) if said predicate has been satisfied in step i), then outputting results and discarding buffers used to store intermediate mark-up language document nodes that can be part of results, else
performing steps b-d until an end document event is received;
else,
performing steps b-d until an end document event is received.

10. A computer-based method of evaluating a query over a mark-up language document by performing incremental evaluation of predicates, as per claim 9, wherein said stream of events are SAX events.

11. A computer-based method of evaluating a query over a mark-up language document by performing incremental evaluation of predicates, as per claim 9, wherein said markup language document is XML.

12. A computer-based method of evaluating a query over a mark-up language document by performing incremental evaluation of predicates, as per claim 9, wherein said query an XPath query.

13. A computer-based method of evaluating a query over a mark-up language document by performing incremental evaluation of predicates, as per claim 9, wherein said incremental evaluation of predicates reduces buffering requirements by i) avoiding storing all evaluation sequences and ii) determining earlier that a predicate has been satisfied and outputting results immediately.

14. A computer-based method of evaluating a query over a mark-up language document by performing incremental evaluation of predicates, as per claim 9, wherein said incremental evaluation of predicate step utilizes algebraic properties of an operator in said predicate to reduce buffering requirements.

15. A computer-based method of evaluating a query over a mark-up language document by performing incremental evaluation of predicates, as per claim 9, wherein said predicate is uni-variate or multi-variate.

16. A computer-based system to evaluate a query over a mark-up language document by performing incremental evaluation of predicates, said system comprising:
a query parser receiving said query and generating a parse tree;
a markup-language document processor receiving markup-language document nodes and generating a stream of events;
buffers comprising said predicate buffers and said result buffers, said predicate buffers used to store mark-up language document nodes participating in said predicate evaluation and said result buffers used to store intermediate mark-up language document nodes that can be part of results; and
an evaluator: receiving said generated parse tree and said generated stream of events; evaluating said received parse tree by reading events one by one from said received stream of events and matching said read events with nodes in said parse tree; buffering mark-up language document nodes for said matched read events; and performing incremental evaluation of predicates and discarding predicate buffers if said read events match a node in said parse tree that is a term in a predicate; and outputting results and discarding result buffers if said predicate has been satisfied.

17. A computer-based system to evaluate a query over a mark-up language document by performing incremental evaluation of predicates, as per claim 16, wherein said stream of events are SAX events.

18. A computer-based system to evaluate a query over a mark-up language document by performing incremental evaluation of predicates, as per claim 16, wherein said markup language document is XML.

19. A computer-based system to evaluate a query over a mark-up language document by performing incremental evaluation of predicates, as per claim 16, wherein said query an XPath query.

20. A computer-based system to evaluate a query over a mark-up language document by performing incremental evaluation of predicates, as per claim 16, wherein said incremental evaluation of predicates performed by said evaluator reduces buffering requirements by i) avoiding storing all evaluation sequences and ii) determining earlier that a predicate has been satisfied and outputting results immediately.

21. A computer-based system to evaluate a query over a mark-up language document by performing incremental evaluation of predicates, as per claim 16, wherein said predicate is uni-variate or multi-variate.
